(19) United States
(12) Patent Application Publication
(10) Pub. No.: US 2014/0233515 A1
(43) Pub. Date: Aug. 21, 2014

(54) METHOD OF RESOURCE SCHEDULING USED FOR MACHINE TYPE COMMUNICATIONS

(71) Applicants: Yu Chen, Shanghai (CN); Jialin Zou, Randolph, NJ (US); Sudeep Palat, Swindon (GB)

(72) Inventors: Yu Chen, Shanghai (CN); Jialin Zou, Randolph, NJ (US); Sudeep Palat, Swindon (GB)

(73) Assignee: ALCATEL LUCENT, Paris (FR)

(21) Appl. No.: 14/346,063

(22) PCT Filed: Sep. 14, 2012
(86) PCT No.: PCT/IB2012/002019

§ 371 Date: Mar. 20, 2014

(30) Foreign Application Priority Data
Sep. 30, 2011 (CN) 201110300055.0

(51) Int. Cl. H04L 5/00

(52) U.S. Cl. CPC H04L 5/0037
USPC 370/329

(57) ABSTRACT

The invention relates to a method of implementing resource scheduling for MTC devices, the base station assigns multiple machine type communication (MTC) devices to a group, and allocates to each device a sequence number of the group respectively, informs each corresponding device of the sequence number of the device, allocates a resource set for the group, and transmits indication information, indicating the resource set, to each device via broadcast signaling, wherein, the sequence number is used to indicate the resource, in the resource set, used by the device. A MTC device determines the resource, in the resource set, used by the device based on the sequence number. The embodiment of the invention can save the overhead of MTC resource scheduling.

### TECHNICAL FIELD

The disclosure relates to a wireless communication technology, more particularly, relates to the method of resource scheduling used for machine type communications (MTC).

### BACKGROUND

In 3GPP, the hot discussion focused on MTC devices is that a great deal of MTC user devices access and each user device has only a few packets of data transmission. E.g. for intelligent measurement, there are a lot of MTC devices, but each MTC device only transmits one packet of data each time. In the present, the signaling needed for resource scheduling of each data transmission is the same, regardless whether the requested resources are tens or thousands of bits. The signaling needs occupy 46 bits of physical downlink control channel (PDCCH). Thus, for a few packets of data, e.g. data of tens of bits, the signaling overhead is considerable. It may be predicted that in future communication activities, MTC will occupy a major part. Therefore for the network supporting MTC service, the signaling overhead for the whole network is not a negligible burden.

It's a solution scheme that assigning multiple MTC devices to one group for unified management to overcome above problems. Currently there are some discussions in 3GPP, but no effective technical scheme is proposed. E.g. in R2-102142, the need for grouping is pointed out, but there is no detailed technical scheme implementing resource scheduling based on grouping. In R2-112953, the grouping based on MBMS (multimedia broadcast multicast service) is discussed, but it requires MTC devices supporting MBMS, which causes certain difficulty to the promotion of the scheme.

### SUMMARY OF THE INVENTION

In order to solve the above technical problem of large signaling overhead of MTC resource scheduling, the invention aims to provide a detailed resource scheduling scheme based on MTC device groups.

The inventive concept of the invention is assigning multiple MTC devices to a group and allocating each device a sequence number of the group respectively. The base station informs the sequence number of each device to the corresponding device, and the overhead is quite small. And the base station allocates a resource set for the group as a whole, and informs all MTC devices in the group of the resource set via broadcast. Thus the resource scheduling signaling is used for only once for multiple MTC devices, which reduces overhead. Each MTC device finds the resource corresponding to itself in the resource set based on its sequence number, to implement communication.

One aspect of the disclosure provides a method of implementing resource scheduling for MTC devices, in a base station, wherein, the method comprises the following steps:

i. assigning multiple MTC devices to a group, and allocating to each device a sequence number of the group respectively;

ii. informing each corresponding device of the sequence number of the device;

iii. allocating a resource set for the group, and transmitting indication information, indicating the resource set, to each device via broadcast signaling;

wherein, the sequence number is used to indicate the resource, in the resource set, used by the device.

The aspect provides a detailed technical solution of resource scheduling based on MTC device groups, which can save the overhead of MTC resource scheduling.

In an embodiment, the group has a group ID, the step ii informs each device of the group ID, wherein, the group ID and the sequence number indicate the used resource. The embodiment can support multiple MTC device groups in the network, which improves the flexibility of resource scheduling.

In an embodiment, the step i comprises assigning the devices running the same application to a group, and allocating a sequence number to each device. The advantage of the embodiment is that, since the devices running the same application have similar communication features, e.g. communication time and data amount are the same, thus they may be unified to be allocated with resource to save overhead.

In an embodiment, the method also comprises the following steps before the step iii:

informing each device of a scheduling period;

the step iii is repeated at the scheduling period.

The advantage of the embodiment is that, it can agree with a MTC device to schedule periodically, without informing the MTC device of the scheduling time each time, and it may allow the MTC device not monitoring the channel at non-scheduling time so as to save power.

In an embodiment, the method further comprises the following steps:

informing each device of an updated scheduling strategy;

The scheduling strategy comprises any of the following items:
the scheduling period;
a manner in which the sequence number indicates the used resource.

The advantage of the embodiment is allowing a change of a scheduling strategy, and improving the flexibility of resource scheduling.

In an embodiment, the step i comprises the following steps:
receiving scheduling requests from several devices within a certain time window, wherein the scheduling requests correspond to the same and/or different applications;
allocating the sequence numbers to the several devices.

The advantage of the embodiment is dynamically allocating a resource set for the MTC devices that are requesting resource, and unified to schedule, with high flexibility.

Accordingly, another aspect of the invention provides a method of implementing resource scheduling, in MTC devices, wherein, the method comprises the following steps:

i. receiving a sequence number of the device in a group, wherein, the group comprises the device and at least other one MTC device;

ii. receiving indication information, indicating a resource set, via broadcast, the resource set is allocated for the group by the base station, the sequence number is used to indicate the resource, in the resource set, used by the device;

iii. determining the resource, in the resource set, used by the device based on the sequence number.

### BRIEF DESCRIPTION OF DRAWINGS

By reading the detailed description of unlimited embodiments referring to the following drawings, other features, purpose and advantages of the invention will be more obvious:

FIG. 1 is a schematic diagram of grouping MTC devices according to the invention.

FIG. 2 is a schematic diagram of the corresponding relations between the sequence numbers of MTC devices in the group and their used resource blocks, according to an embodiment of the invention;

FIG. 3 is a schematic diagram of a periodical scheduling, according to an embodiment of the invention;

FIG. 4 is a flow chart of dynamically resource scheduling, according to another embodiment of the invention.

### DETAILED EMBODIMENT

A base station assigns multiple MTC devices to a group, and allocates to each device a sequence number of the group respectively, informs each corresponding device of the sequence number of the device, allocates a resource set for the group, and transmits indication information, indicating the resource set, to each device via broadcast signaling, wherein, the sequence number is used to indicate the resource, in the resource set, used by the device. A MTC device determines the resource, in the resource set, used by the device based on the sequence number.

First, the following describes in detail the method flow of a resource scheduling for MTC devices running the same application, according to the first embodiment of the invention.

For MTC devices running the same application, they have such features: accessing the network intensively in a relatively short time window, and uploading the same type of data, therefore they follow the same signaling flow. Thus, the embodiment assigns these MTC devices to a group and implements scheduling.

In detail, the base station assigns multiple MTC devices to a group, and each device corresponds to a sequence ID in the group respectively. In general, the sequence ID of each device remains unchanged in the current session.

Preferably, the base station may maintain multiple groups, and in this case the base station assigns a group ID for each group respectively.

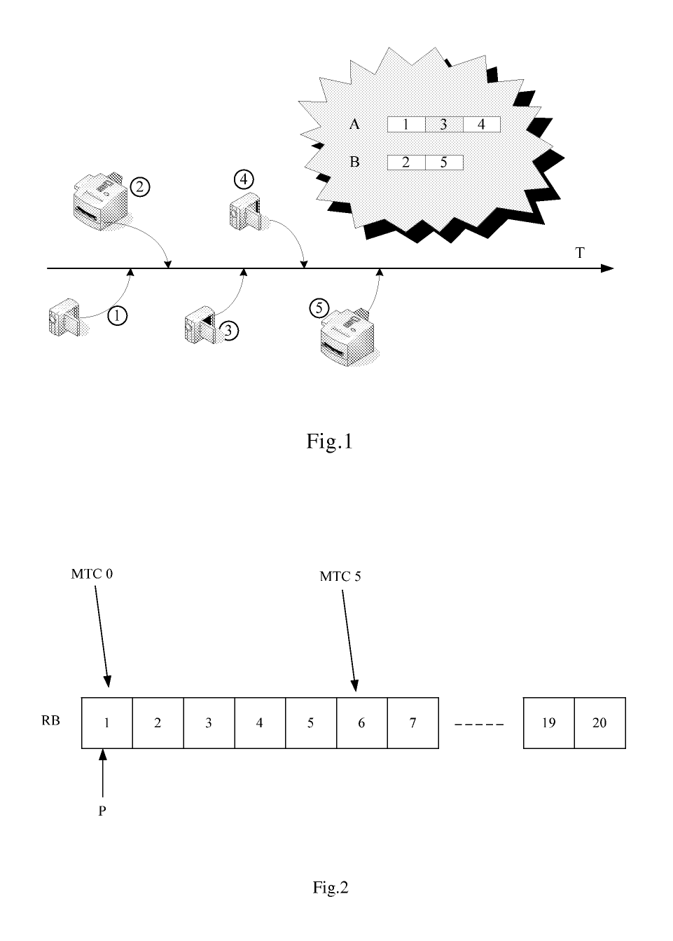

The grouping procedure may be implemented when each device registers to the network. As illustrated in FIG. 1, T identifies the time axis, and MTC devices 1-5 register to the network in series. The base station, according to the applications run by each MTC device, assigns MTC devices 1, 3 and 4 to group A, and assigns MTC devices 2 and 5 to group B.

After grouping, the base station informs the corresponding device of its group ID and sequence number in the group. Preferably, the base station may transmit these information to MTC devices through RRC Connection Setup message, which may avoid introducing overheads.

Accordingly, MTC devices receive the group ID to which the device belongs and its sequence number in the group.

In many cases, there are a large number of MTC devices, and each device only periodically transmits a small quantity of data packets. And, MTC devices have a certain delay tolerance mechanisms, i.e. the data to be transmitted may be transmitted a moment later after being generated. Then, preferably, the resource scheduling may be periodically implemented, informing, at a certain interval, each device of the communication resource occupied by its transmission of the data packets. For this purpose, the base station can inform each MTC device of the scheduling period. E.g. the base station informs MTC devices that the scheduling takes 100 ms as the period.

Accordingly, the MTC devices receive the scheduling period.

Later, as the scheduling time comes, the base station allocates a resource set for the group, and transmitting indication information, indicating the resource set, to each device via broadcast signaling. Accordingly, each MTC device receives the indication information indicating the resource set via broadcast.

In detail, since each MTC device only transmits a small quantity of data packets, for a single MTC device, one or several resource blocks (RBs) are enough. For a MTC device group, the resource set composed of tens or hundreds of RBs may be needed. For the system with more than 10 RBs, the type 0 is generally used to indicate the multiple RBs, therefore it's inefficient to indicate the resource set with the type 0. The type 2 may be used to complete the job, the type 2 defines the starting position and the quantity of RBs, therefore it can well indicate the resource set. Usually, it need log ₂ (N_{RB}^{DL}(N_{RB}^{DL}+1)) bits, wherein N is the quantity of RBs. For a resource set needing 110 RBs, 14 bits are needed. Thus, for the resource set, total quantity of RBs may be indicated efficiently.

In the scheduling time, the base station uses the resource set, indicated by the type 2, as the indication information, and transmits it to each MTC device via PDCCH broadcast. In order to facilitate MTC devices determining the indication information corresponding to its own group, the base station also transmits the group ID of the group altogether. As the scheduling time comes, each MTC device monitors PDCCH channel, and receives the indication information corresponding to the group the MTC belonging to, thereby determining the resource set occupied by the group.

Then, the MTC device can determine the RB(s) used by the user device, in the resource set, by using the sequence number of the device in the group.

In an example, if there are 20 MTC devices in the group, the base station will assign continuous RBs to the MTC devices with sequence number 0-19 in series, and the resource set composed of 20 RBs is indicated by the type 2. Each MTC device starts from the beginning position P of the RB indicated by the type 2, and determines the used RB based on the sequence number of the MTC device in the group. E.g. for the MTC device with the sequence number 0, it uses the first RB indicated by the beginning position P, and for the MTC device with the sequence number 5, it uses the fifth RB after the beginning position P, shown as FIG. 2.

Based on determined RB(s), MTC devices transmit data packets at corresponding time/frequency to communicate with the base station.

If any error occurs during the communication, the MTC device will turn to use its own ID, e.g. C-RNTI, to implement HARQ communication with the base station, which is the same MTC devices communication mode in current technology, thus it'll not described in detail.

Preferably, if the scheduling strategy of the group is changed, e.g. the base station assigns each MTC device two RBs, or the scheduling period is updated, the base station will broadcast the updated scheduling strategy to MTC devices of the group.

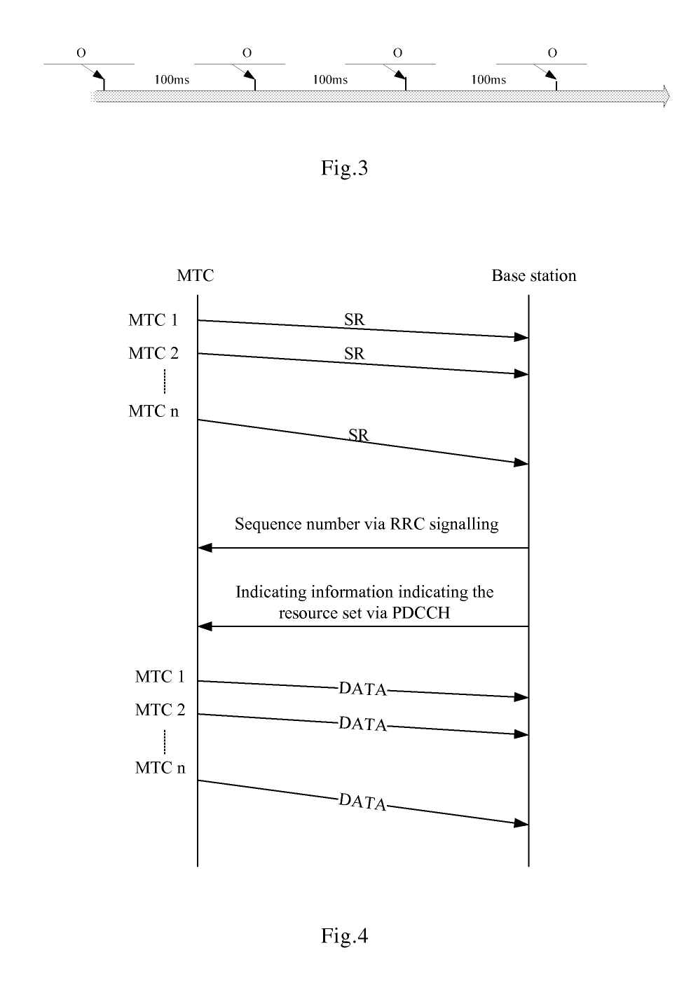

As the next scheduling time comes, the above scheduling process repeats. As shown in FIG. 3, the scheduling period is 100 ms, and the reference sign O stands for the implementations of the above scheduling process.

It may be understood that the above technical solution, of informing of the scheduling period and implementing periodical scheduling, is just an example. The base station may directly transmit the indication information when needing resource scheduling, while MTC devices continuously monitor PDCCH channel to receive the indication information and determine communication resources to communicate.

The above is a detailed description of the grouping and scheduling method of MTC devices running the same application, according to the first embodiment of the invention. The following will describe in detail the method and procedure of dynamical resource scheduling for MTC devices that are requesting resources, according to the second embodiment of the invention.

In the embodiment, grouping is done as MTC devices accesses the network, which is similar with previous embodiment, but the grouping may be not limited to whether the running application is the same or not. Different with the above embodiment, the base station dynamically assigns the sequence numbers of MTC devices in the group for the MTC devices that are needing resources, and the base station allocates the resource set for the MTC devices.

In detail, several MTC devices that are needing resources send scheduling request (SR for short) to the base station. As shown in FIG. 4, in a time window, there are n MTC devices, i.e. MTC1, MTC2, . . . MTCn have sent a SR. After the time window, the base station device determines that the n MTC devices need resources, then it will assign a sequence number in group for each of the n MTC devices respectively. And, the base station transmits the mapping relation between the sequence number and the ID of device such as C-RNTI, to each MTC device. In one case, the transmission may be via broadcast, i.e. the one to one mapping relations between all sequence numbers and C-RNTIs are transmitted to each MTC device via RRC signaling, each MTC device finds sequence number corresponding to its C-RNTI respectively. It may be transmitted repeatedly with high coding rate to avoid lost. If a MTC device still can't receive correctly the sequence number of the device yet, then it will implement HARQ retransmission to communicate based on the device C-RNTI, which is current technology and won't be described in detail. If there are 100 devices in the group, and the retransmission rate is 10%, then signaling overhead may be reduced by about 89%.

Accordingly, MTC devices receive the sequence numbers. E.g. after a MTC device sends SR, it continuously monitors and receives the sequence number transmitted by the base station. In the case that there are multiple groups in the network, the sequence numbers should have the group IDs to facilitate MTC devices to distinguish.

If a MTC device enters the idle mode, it will be removed from the group, e.g. via RRC connection release message.

Similar with the above first embodiment, the base station may allocate a resource set for the MTC device group, and broadcast the indication information, indicating the resource set, to each MTC device via PDCCH. Each MTC device finds its used RB(s) from the resource set based on the obtained sequence number in the group, in order to communicate. If the MTC device doesn't receive the sequence number, it won't determine its used RB, and it will use HARQ to communicate.

Although the above document describes the detailed description of different embodiments of the invention, it should be understood that, the legal scope of the invention is defined by the text of the appended claims. The detailed description should be construed only as examples, not the description of each possible embodiment of the invention, since the description of each possible embodiment is, if possible, not practical. It still fall in the scope of the claims of the invention to use current technology or the technology developed after the patent application date, to realize each replaceable embodiment.

Though the disclosure describes detailed embodiment, the invention isn't limited by the provided examples, and is defined to include the content limited by the following scope and spirit of claims.

1. A method of implementing resource scheduling for MTC devices, in a base station, wherein, the method comprises the following:
assigning multiple MTC devices to a group, and allocating to each device a sequence number of the group respectively;
informing each corresponding device of the sequence number of the device;
allocating a resource set for the group, and transmitting indication information, indicating the resource set, to each device via broadcast signaling;
wherein, the sequence number is used to indicate the resource, in the resource set, used by the device.

2. A method of claim 1, wherein, the group has a group ID, the informing informs each device of the group ID, wherein, the group ID and the sequence number indicate the used resource.

3. A method of claim 1, wherein, the assigning comprises:
assigning the devices running the same application to the group, and allocating a sequence number for each device.

4. A method of claim 3, wherein, the method further comprises the following steps before the allocating:
informing each device of a scheduling period;
the allocating is repeated at the scheduling period.

5. A method of claim 4, wherein, the method further comprises the following:
informing each device of an updated scheduling strategy;
the scheduling strategy comprises any of the following items:
the scheduling period;
a manner in which the sequence number indicates the used resource.

6. A method of claim 1, wherein, the assigning comprises the following:
receiving scheduling requests from several devices within a certain time window, wherein the scheduling requests correspond to the same and/or different applications;
allocating the sequence numbers to the several devices.

7. A method of claim 1, wherein, the informing transmits to respective devices via broadcast the one-to-one corresponding relations between each sequence number and an ID of each device;
transmits the indication information in the physical downlink control channel.

8. A method of implementing resource scheduling, in MTC devices, wherein, the method comprises the following:
receiving a sequence number of the device in a group, wherein, the group comprises the device and at least other one MTC device;
receiving indication information, indicating a resource set, via broadcast, the resource set is allocated for the group by the base station, the sequence number is used to indicate the resource, in the resource set, used by the device;
determining the resource, in the resource set, used by the device based on the sequence number.

9. A method of claim 8, wherein, the group further has a group ID, the receiving a sequence number further receives the group ID, wherein, the group ID and the sequence number are used to indicate the used resource.

10. A method of claim 8, wherein, the device and the at least other one device run the same application.

11. A method of claim 10, wherein, the receiving indication information comprises:
monitoring continuously to receive the indication information, after the receiving a sequence number;
Or, before the receiving indication information, the method also comprises the following:
receiving a scheduling period from the base station;
the receiving indication information and the determining repeat at the scheduling period.

12. A method of claim 11, wherein, the method also comprises the following:
receiving an updated scheduling strategy from the base station;
the scheduling strategy comprises any of the following items:
the scheduling period;
a manner in which the sequence number indicates the used resource;
the receiving indication information and the determining determine the used resource by using the updated scheduling strategy.

13. A method of claim 8, wherein, the method comprises the following before receiving a sequence number:
sending a scheduling request to the base station within a certain time window.

14. A method of claim 8, wherein, the method comprises the following:
using an ID of the device to implement HARQ communication, when not correctly receiving the sequence number and/or the indication information;
communicating with the base station based on the determined resource, when correctly receiving the sequence number and/or the indication information;
and when errors occur in the communication, using the ID of the device to implement HARQ communication.

15. A method of claim 8, wherein, in the receiving a sequence number receives the one-to-one corresponding relations between each sequence number and an ID of each device via broadcast, and determines the sequence number corresponding to the device according to the ID of the device;
the receiving indication information receives the indication information in the physical downlink control channel.
